(19) United States
(12) Patent Application Publication
(10) Pub. No.: US 2020/0251264 A1
(43) Pub. Date: Aug. 6, 2020

(54) MAGNETIC CORE AND METHOD FOR PRODUCING A MAGNETIC CORE

(71) Applicant: Robert Bosch GmbH, Stuttgart (DE)

(72) Inventors: Jivan Kapoor, Stuttgart (DE); Thomas Plum, Koeln (DE)

(21) Appl. No.: 16/639,272

(22) PCT Filed: Aug. 9, 2018
(86) PCT No.: PCT/EP2018/071574

§ 371 Date: Feb. 14, 2020

(30) Foreign Application Priority Data
Aug. 15, 2017 (DE) 10 2017 214 220.0

(51) Int. Cl. H01F 3/14; H01F 41/00; H01F 41/02

(52) U.S. Cl. CPC H01F 3/14; H01F 41/0206; H01F 41/005

(57) ABSTRACT

The invention relates to a slotted magnetic core having multiple gaps, as well as a production method for a magnetic core of this type. In a main body made as of a magnetic ferrite, multiple gaps are introduced into the main body, which, however, only partially penetrate the main body. The main body with the gaps is subsequently secured by a casing and then a section of the main body is removed, such that the magnetic ferrite breaks apart into multiple individual segments, which are only held together by the casing.

### BACKGROUND OF THE INVENTION

The present invention relates to a method for producing a slotted magnetic core and to a slotted magnetic core.

Document DE 10 2015 218 715 A1 discloses a a power converter module comprising a circuit board in which an iron core is integrated in recesses of the circuit board. A winding, which forms a secondary circuit of the power converter module, is arranged on the circuit board.

For applications in power electronics, inductive components are very often used for energy conversion. Switched-mode power supply units are an example of this. Soft-magnetic cores with one or more gaps, in particular with air gaps, are preferably used for the inductive components.

In the course of the miniaturization of subassemblies, ever smaller inductive components are also being used. Consequently, cores of a smaller overall size are also increasingly required for the inductive components.

### SUMMARY OF THE INVENTION

The present invention discloses a method for producing a magnetic core, in particular a coil core and a magnetic core.

The following is accordingly provided:

A method for producing a magnetic core. The method comprises a step for providing a main body comprising a magnetic ferrite. The main body comprises along a virtual axis of the main body a first subregion and a second subregion, which adjoins the first subregion in the axial or radial direction with respect to the virtual axis. The method comprises a further step for introducing multiple gaps into the first subregion of the main body. The gaps introduced run radially in relation to the virtual axis in the main body. The gaps only penetrate the first subregion of the main body. The second subregion preferably remains free of gaps. In a further step, the main body with the gaps is encased in an electrically insulating material. The electrically insulating encasing at the same time also undertakes a function of mechanically stabilizing the main body with the gaps. Finally, the second subregion of the main body is removed, so that only the slotted and encased first subregion of the main body remains.

The following is also provided:

A magnetic core with a main body comprising a magnetic ferrite, which has a metal-free inner region along a virtual axis. The inner region is adjoined in the radial direction with respect to the virtual axis by the main body comprising the ferrite. The main body comprises multiple gaps running radially in relation to one another. These gaps divide the main body into multiple separate segments. Furthermore, the main body is at least partially encased in an electrically insulating material, which stabilizes the main body with the gaps.

The present invention is based on the awareness that the production of small magnetic cores with air gaps presents a challenge.

On account of the air gaps in a core, the core of a magnetic ferrite is divided into multiple individual segments. In the case of conventional cores, the individual segments are generally not connected to one another at all. Especially in the course of miniaturization, joining the individual segments of such a core together with precision to form an overall component is therefore a great challenge.

The present invention is therefore based on the idea of acknowledging this awareness and providing a method for producing slotted cores, in particular cores of a smaller overall size, which on the one hand can be realized easily and with exactly defined gap dimensions, and which additionally creates a core that can also be further processed easily, efficiently and consequently at low cost.

In particular, an idea of the present invention in this context is to use as the starting basis for a slotted magnetic core a solid main body comprising for example a magnetic ferrite. First, the desired gaps are introduced into this solid main body. The desired gaps generally run radially toward a virtual axis in the main body. However, the gaps are not introduced completely into the main body in the axial or radial direction, but only partially, so that the main body is held together by the unslotted subregion. Then, the main body is at least partially encased. The encasing comprises in particular an encasing of an outer lateral surface of the main body into which the gaps have been introduced. Furthermore, the end faces, from which the virtual axis extends, may also be at least partially encased. Preferably, during the encasing, the regions of the main body with the gaps are covered over. Such an encasing allows the main body with the gaps to be stabilized. Then, the subregion of the main body which until then holds the slotted main body together can be removed. During this, the individual segments that are formed by the gaps continue to remain fixed in their relative position in relation to one another as a result of the stabilizing encasing.

Consequently, a subregion of the main body that extends up to the gaps in the main body can be removed along the virtual axis. As a result of the stabilizing encasing, even after the removal of the corresponding subregion, the individual segments comprising the magnetic ferrite still cannot fall apart.

In this way, a magnetic core with multiple air gaps can be created in a particularly easy, efficient, quick and low-cost way. The individual segments of the magnetic core remain fixed in their relative position in relation to one another during the entire production process, so that there is no need for laboriously arranging separate segments of a magnetic core. In particular, very precise air gaps can be created, especially in the case of small slotted magnetic cores.

The introduction of the gaps into the main body may be performed by means of any desired suitable method. For example, the gaps may be introduced into the main body by means of sawing, in particular micro sawing. However, other methods, such as for example structuring by means of a laser beam or cutting by means of a fluid jet, for example a water jet or the like, may also be used for introducing the gaps into the main body. In this way, particularly narrow gaps can be introduced into the main body. In principle, the method is also suitable for magnetic cores with only one gap. The particular advantage of the method is obtained however especially in the case of magnetic cores with multiple air gaps, for example two, three, four, six, eight or any other desired number of air gaps.

The width of the air gaps may be constant over the entire gap in the radial direction and/or in the axial direction. Alternatively, it is also possible that the width of the segments varies in the radial direction and/or in the axial direction. Thus, the width of the gaps may increase or decrease continuously or else in stages, either in the axial direction or in the radial direction or possibly also in both directions

According to one embodiment, the removal of the second subregion may comprise drilling, in particular drilling out, of an inner region of the main body. However, any other desired methods for removing the second subregion, such as for example milling, cutting by means of laser beam, water jet or any other desired suitable method for removing the second subregion, are also possible. Depending on the method used for the second subregion, the desired structure and form of the core can be achieved in each case by the removal of the second subregion. The removal of the second subregion is performed at least up to the gaps that have been introduced into the first subregion of the main body. In this way, individual segments comprising magnetic ferrite that are only fixed with respect to one another by the encasing of the main body are obtained after the introduction of the gaps and the removal of the second subregion.

The outer dimensions of the magnetic core can be predetermined very easily by the main body provided. In particular, the main body may be obtained in any desired production process. For example, the main body may be realized by pressing a basic material comprising a magnetic ferrite and possibly subsequently sintering the pressed main body.

In principle, it is also possible, for example, to combine the steps of providing the main body and introducing the air gaps and to produce already a main body with corresponding gaps, which is subsequently encased according to the invention and then the second subregion is removed.

Any desired suitable magnetic materials, in particular ferromagnetic or ferrimagnetic materials, may be used as magnetic material for the main body.

According to one embodiment, the gaps that are introduced into the main body comprise a width of less than 1 mm. In particular, the gaps that are introduced into the main body may have a width of at most 500 micrometers, 200 micrometers, possibly also at most 100 micrometers or at most 50 micrometers. Gaps with a smaller width or a width of one millimeter or more are also possible. In this way, slotted magnetic cores with particularly small gaps can be produced. In particular, the width of the gaps may also increase or decrease in the axial and/or radial direction.

According to one embodiment, the main body provided has a rotationally symmetrical form. In particular, the axis of symmetry of the rotationally symmetrical main body may correspond to the virtual axis. Rotationally symmetrical should be understood in this connection as meaning that a main body can be transferred onto itself by rotation about the axis of symmetry by a predetermined angle. The predetermined angle may in particular correspond to a value of an integral part of 360°. Consequently, a main body may for example have a base area of a regular polygon.

According to one embodiment, the main body has a circular or oval cross section. Furthermore, the main body may also have a rectangular or square cross section. Such main bodies are particularly well-suited for use as a magnetic core.

According to one embodiment, the step for encasing the main body comprises encasing the main body by means of injection-molding processes. Injection-molding processes are particularly well-suited for the selective encasing of the main body. In particular, a further structuring of the encasing may also be realized thereby for additional desired properties of the encasing. For example, a structuring for guides of electrical conductors or a connecting element may be integrated at the same time into the encasing. Furthermore, it is also possible to apply to the main body an encasing of one or more parts. The part or parts may have been produced previously in a separate process. The application of the previously produced parts may be performed by means of any desired suitable method, for example by adhesive bonding, potting or the like.

According to one embodiment, the encasing of the main body comprises introducing the material for the encasing, in particular an electrically insulating material, into the gaps of the main body. In this way, particularly great stabilization of the magnetic core can be achieved. Alternatively, the encasing of the main body may also be applied only to the outer sides of the main body, while the gaps of the main body remain free of material. In this case, the gaps of the main body are filled with air (or a gas) and the fixing of the segments of the magnetic core is only provided by the outer sides.

According to one embodiment, the magnetic core comprises a main body which is divided by gaps into multiple individual segments. Here, the gaps in the main body may have a width of several millimeters, one millimeter or less than 1 mm, in particular less than 500 micrometers, 200 micrometers, 100 micrometers or less than 50 micrometers. The diameter or the width of the magnetic core may be one or more centimeters, for example 2 cm, 3 cm, 4 cm, 5 cm, etc. The height of the main body, i.e. the extent along the virtual axis, may be for example one or more centimeters. Heights of less than 1 cm, for example 8, 5 or 3 mm, are possible.

According to one embodiment, the encasing of the main body protrudes at least partially into an inner region of the main body. This inner region may be in particular a material-free region around the virtual axis. The inner region is adjoined in the radial direction with respect to the virtual axis by the ferrite of the main body. The at least partial encasing of the inner region may be performed for example by a subsequent forming of the encasing, once the second partial region has been removed. For example, a suitable structuring may be provided on the encasing, partially introduced into the inner region of the main body after the removal of the second subregion by means of a suitable method, for example thermal forming or the like. In this way, a winding later applied around the slotted magnetic core can be applied particularly gently.

According to one embodiment, the magnetic core comprises a protective element. The protective element is arranged on a side of the main body that is facing the inner region. The protective element may be a prefabricated component which is introduced into the inner region of the main body. For example, the protective element may be an injection-molded part or the like. The protective element may be adhesively bonded or welded to the main body or be connected to the main body in some other way.

According to one embodiment of the core, the gaps have a variable width in the radial direction and/or in a direction parallel to the axis of symmetry. In this way, the inductance value of the magnetic core can be made current-dependent. This leads in particular to a load-dependent efficiency, and to the associated advantages.

If appropriate, the above configurations and developments can be combined with one another in any way desired. Further configurations, developments and implementations of the invention also comprise combinations not explicitly mentioned of features of the invention that are described above or below with respect to the exemplary embodiments. In particular, a person skilled in the art will also add individual aspects as improvements or additions to the respective basic forms of the present invention.

### BRIEF DESCRIPTION OF THE DRAWINGS

The present invention is explained in more detail below on the basis of the exemplary embodiments indicated in the schematic figures of the drawings, in which:

FIG. 1 shows a schematic representation of a perspective view of a main body for producing a magnetic core according to one embodiment;

FIGS. 2a, 2b show schematic representations of a perspective view of a main body with gaps introduced, for producing a magnetic core according to two embodiments;

FIGS. 3a, 3b show schematic representations of a cross section through an encased main body for producing a magnetic core according to two embodiments;

FIGS. 4a, 4b show schematic representations of a cross section through an encased main body according to two embodiments;

FIG. 5 shows a schematic representation of a cross section through an encased main body for the production of a magnetic core according to one embodiment;

FIG. 6 shows a schematic representation of a cross section through an encased main body for the production of a magnetic core according to a further embodiment; and

FIG. 7 shows a schematic representation of a flow diagram, as used as a basis for a method for producing a slotted magnetic core according to one embodiment.

### DETAILED DESCRIPTION

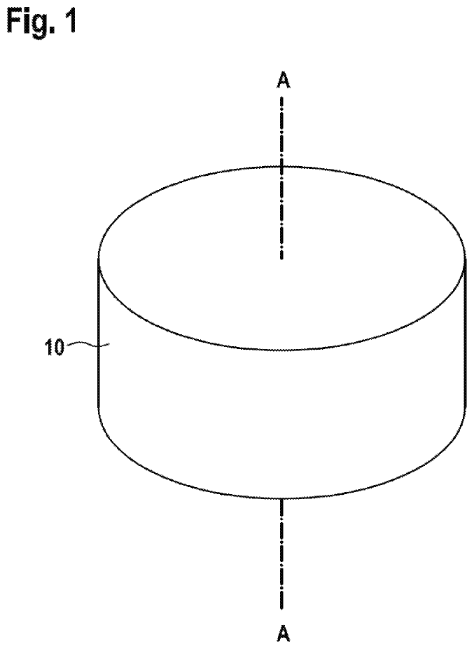

FIG. 1 shows a perspective view of a main body 10, as can be used for example as a starting product for the production of a slotted magnetic core. In the embodiment represented here, the main body 10 is a cylindrical main body 10 with an axis of symmetry A-A. However, the embodiment represented here of a cylindrical, solid main body 10 only serves for better understanding. Any desired main bodies 10 of a different form are additionally also possible. For example, a main body with an oval cross section may also be used as the main body 10. Similarly, main bodies 10 with a rectangular or square cross section are also possible. Further main bodies 10, for example rotationally symmetrical main bodies 10, are also possible. The term “rotationally symmetrical” should be understood here as meaning a body that can be transferred onto itself by rotation about a predetermined angle. The predetermined angle can be taken as meaning any desired fraction of 360°, in particular an angle of 360 degrees/n, where n is an integer of at least 2. Such rotationally symmetrical main bodies likewise have an axis of symmetry, which may in particular correspond to the axis of symmetry A-A of the cylindrical main body 10. Furthermore, main bodies 10 with any desired other form are also possible. In this case, a virtual axis may be provided in the main body 10 instead of the axis of symmetry A-A.

The main body 10 may be produced completely from a magnetic material, such as for example a ferrite. In principle, however, it is also possible that, along with the magnetic ferrite, the main body 10 also comprises further material fractions. The main body 10 may for example be produced by pressing a material, such as for example a powder of a magnetic ferrite. Such a pressed blank may possibly also be sintered in a further method step. In addition, any desired known or novel methods for producing a main body 10 comprising a magnetic ferrite are also possible.

In the exemplary embodiment represented here, the main body 10 is a solid main body. In addition, main bodies which are made free of material in an inner region 30, in particular in a region along the axis A-A, that is to say are hollow, are also possible in principle.

For the following explanations, a distinction is made between at least two subregions 10a and 10b in the main body 10. The second subregion 10b directly adjoins the first subregion 10a in the axial or radial direction with respect to the axis A-A. The two subregions 10a and 10b may have the same material properties. In particular, the main body 10 with the two subregions 10a and 10b may be produced from the same basic material in one production step. In addition, however, it is also possible that the two subregions 10a and 10b have different material properties. In particular, the material in the first subregion 10a may differ from the material in the second subregion 10b. In principle, the two subregions 10a and 10b of the main body 10 may also first be produced independently of one another and subsequently connected to one another, for example by means of adhesive bonding.

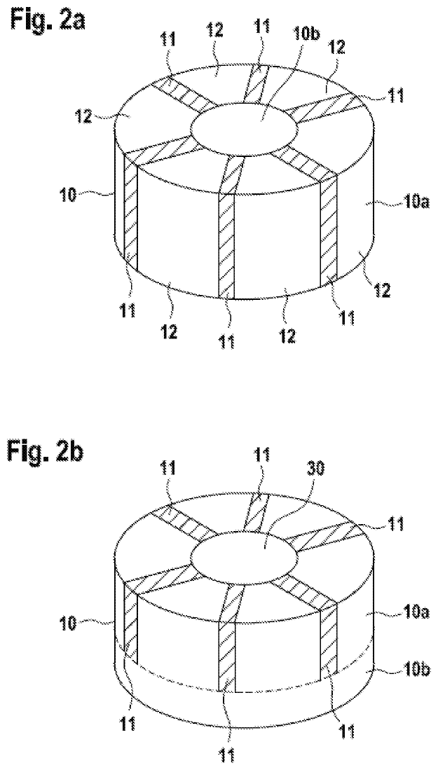

To produce a magnetic core according to the invention, first multiple gaps 11 are introduced into the first subregion 10a of the main body 10, as is represented by way of example in FIG. 2a or 2b. In FIG. 2a, the two subregions 10a and 10b are arranged radially adjacent. Here, the second subregion 10b is closer to the virtual axis A-A. The first subregion 10a, into which the gaps 11 are introduced, is adjoined outwardly in the radial direction by a second subregion 10b.

In FIG. 2b, the two subregions 10a and 10b are arranged axially adjacent along the virtual axis A-A. In this case, as also represented in FIG. 2b, an inner region 30 may be formed free of material in the main body 10. In this case, the main body 10 is consequently hollow inside. In the case of a circular cross section, the main body 10 consequently forms a hollow cylinder. In the case of a main body 10 in which the two subregions 10a and 10b are arranged axially adjacent, the gaps 11 can completely penetrate the main body 10 in the radial direction in the first subregion 10a.

Any desired suitable method may be used for introducing the gaps 11 into the main body 10. For example, the gaps 11 may be introduced into the main body 10 by sawing, in particular by micro sawing. A rotating, vibrating or oscillating saw blade of a desired width may be used for example for the sawing of the gaps 11 into the main body 10. In addition, any desired other methods for introducing the gaps 11 into the main body 10 are also possible. For example, the gaps 11 may also be introduced into the main body 10 by means of a laser beam. Similarly, for example, methods which introduce a gap 11 into the main body 10 by means of a liquid jet or the like are also possible.

The gaps 11 that are introduced into the main body 10 have a width which is preferably smaller than the diameter of a wire with which the main body 10 is to be wound later. Preferably, the gaps 11 may have a width of less than 1 mm. In particular, the gaps 11 may have a width of 500 micrometers or less, for example 200 micrometers, 100 micrometers, 50 micrometers, 20 micrometers or less.

In the exemplary embodiment represented here, the width b of the gaps 11 is constant in the radial direction and parallel to the axis of symmetry A-A. In addition, it is also possible to vary the width b of the gaps 11 in the radial direction and/or parallel to the axis of symmetry A-A. For example, the individual gaps 11 may have multiple portions with different widths b. In this way, the width b of a gap 11 may increase (or decrease) in stages in the radial direction and/or parallel to the axis of symmetry A-A. This can be achieved for example by the introduction of the gaps 11 into the main body 10 being performed in a number of stages. For example, different gap widths for the gaps 11 may be machined in a number of stages one after the other, the depth for the machining of the gap being reduced respectively as the cutting width increases. For example, gaps 11 with different widths may be sawn or cut successively into the main body 10, gaps with a smaller width being introduced deeper into the main body 10, while gaps with a greater width are introduced less deep into the main body 10. Alternatively, the width b of the gaps 11 may also be varied continuously in the radial direction or parallel to the axis of symmetry A-A.

A variation of the width b of the gaps 11 allows the inductance value of the magnetic core 1 to be made current-dependent. This leads in particular to a load-dependent efficiency of applications with a corresponding magnetic core.

The gaps 11 that are introduced into the main body 10 preferably run radially toward a virtual axis, for example the axis A-A. However, the gaps 11 do not run completely through the main body 10, but only penetrate partially into the main body 10. In particular, the gaps 11 are only introduced into the first subregion 10a, while the second subregion 10b, which adjoins the first subregion 10a in the axial or radial direction, is not penetrated by the gaps 11. Consequently, even after the introduction of the gaps 11 into the first subregion 10a of the main body 10, an arrangement in which the main body 10 does not break up into a number of pieces is obtained. The segments 12 in the first subregion 10a of the main body 10 that are obtained due to the gaps 11 are held together by the second subregion 10b of the main body 10.

Preferably, multiple gaps 11 are introduced into the main body 10. For example, at least two gaps 11 or else three, four, six, eight or any other desired number of gaps 11 may be introduced into the main body 10.

In the example represented here, the gaps 11 are arranged uniformly, i.e. equidistantly, in the main body 10. However, such an equidistant distribution of the gaps 11 is not absolutely necessary. It is alternatively also possible to provide a cluster of gaps 11 in one portion of the main body 10. In this case, the individual segments 12 of the main body 10 do not all have the same form.

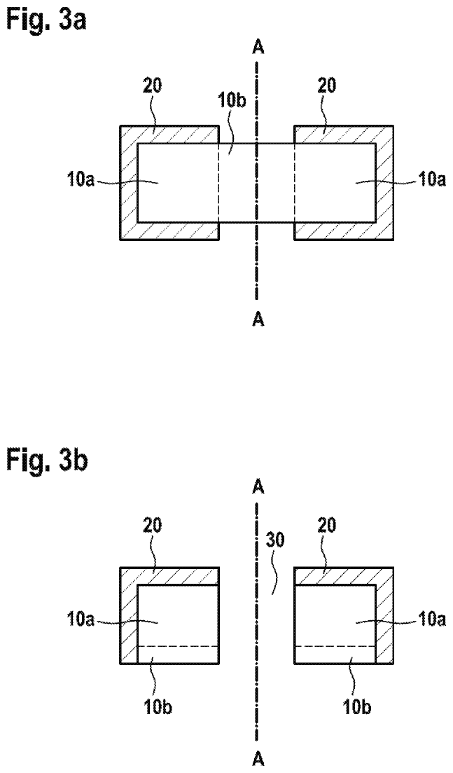

In a further method step, the main body 10 with the gaps 11 is then encased in an electrically insulating material, as is represented in FIGS. 3a and 3b. The term “encase” should be understood as meaning for example that at least part of the outer surface of the main body 10 is coated with an electrically insulating material. For example, the encasing of the main body 10 may be performed by an injection-molding process or the like. In addition, other methods for applying an encasing 20 to the main body 10 are also possible. For example, a suitable electrically insulating substance with the required layer thickness may be deposited onto the main body 10. It is similarly possible to spray or vapor-coat the main body 10 with a suitable material, in order in this way to produce an encasing 20 of the main body 10.

Furthermore, it is also possible to apply an encasing of one or more parts to the main body 10. The part or parts to be applied may be previously produced separately. These separate plastic parts may also be produced for example by means of an injection-molding process. The application of the separate parts may be performed by means of any desired suitable method. For example, the parts may be fixed on the main body 10 by adhesive bonding or the like.

During the encasing of the main body 10, the electrically insulating material may either be applied only to the outer surfaces of the main body 10, or alternatively it is also possible to introduce the electrically insulating material also into the gaps 11 of the main body 10. If the electrically insulating material is also introduced into the gaps 11 of the main body 10, a material that has a permeability which corresponds approximately to the permeability of air should be chosen. In this way, it can be ensured that, even with the material introduced, the gaps 11 have the desired properties of a magnetic core with gaps.

By encasing the main body 10, the main body 10 with the gaps 11 is stabilized in the outer region. During the encasing of the main body 10, a structuring of the encasing 20 may possibly also be performed. For example, this structuring of the encasing 20 may predetermine the path of electrical conductor tracks to be applied later. In addition, structurings for applying electrical contacting with a connecting element or the like may also be already provided during the encasing.

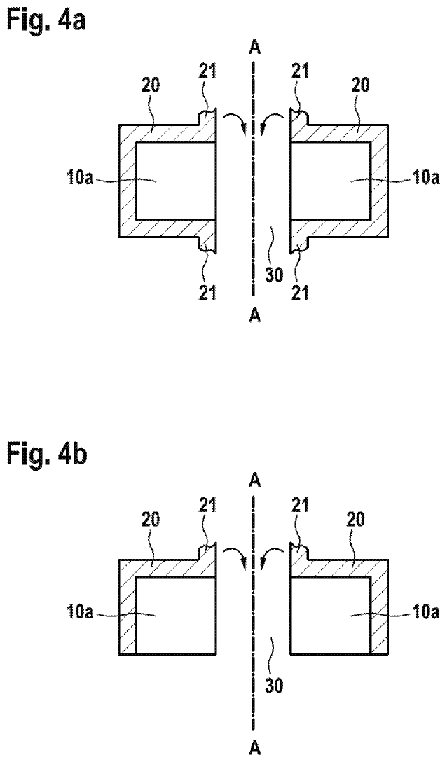

In a further method step, the second subregion 10b of the main body 10 may then be removed, as is represented in FIGS. 4a and 4b. In this way, such a subregion is removed from the main body 10 that the remaining material of the main body 10 breaks up into individual segments 12 on account of the gaps 11 in the first subregion 10a. These individual segments 12 of the remaining main body 10 are then only fixed by the encasing 20.

The removal of the second subregion 10b may for example be performed by drilling a hole into the main body 10. The drilling may preferably be performed along the virtual axis A-A. However, any other desired methods for removing the material in the second subregion 10b are also possible. Thus, for example, the second subregion 10b may also be removed by means of milling. Cutting out or cutting away the second subregion 10b by means of a laser beam, a liquid jet or any other desired method is also possible.

In particular if the second subregion 10b consists of a different material than the first subregion 10a, correspondingly suitable other methods may also be used for removing the material of the second subregion 10b. Thus, in this case the material of the second subregion 10b may perhaps also be separated from the first subregion 10a possibly by means of a solvent or the like.

After the removal of the second subregion 10b of the main body 10, the individual segments 12 comprising the magnetic ferrite are only fixed with respect to one another in the main body 10 by the encasing 20. In this way, a magnetic core that has a material-free inner region 30 in the main body 10 along a virtual axis A-A is produced from the main body 10. After the removal of the inner region 30, the main body 10 is divided into individual segments 12 by multiple radially running gaps 11. To stabilize the individual segments 12, the main body 10 is at least partially encased in an electrically insulating material 20.

Such a slotted magnetic core may subsequently be wound by means of an electrical conductor, for example a wire, and thus form a suitable inductance.

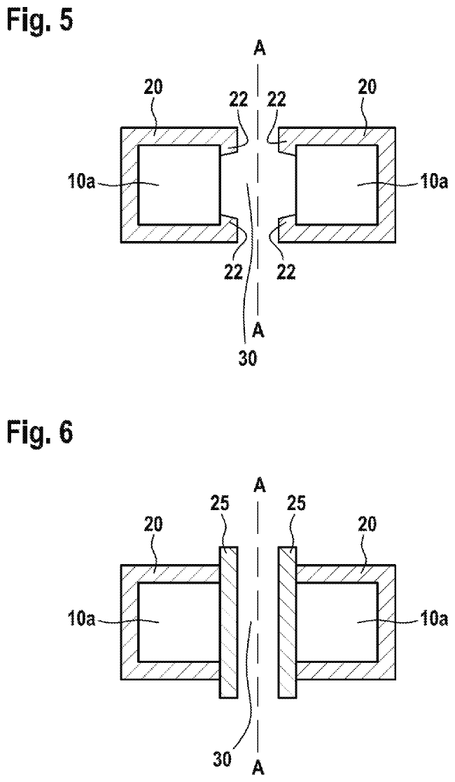

In a further method step, the encasing 20 may possibly also be at least partially introduced into the inner region 30. For this purpose, for example during the previously described encasing of the main body 10, the encasing 20 may be reinforced at the location of the inner region 30, as represented for example in FIGS. 4a and 4b by the reference sign 21. After the removal of the material in the inner region 30 of the main body 10, this reinforced region 21 may be worked into the inner region 30 by means of a suitable method. For example, a thermal forming of the material, in particular of the region with the reinforced material 21, may be performed for this purpose. Thus, for example, the material in the region 21 may be worked into the inner region 30 by flanging or some other suitable method. In this way, an encasing 22 can also be at least partially realized in the inner region 30, as is represented for example in FIG. 5. As a result, conductor tracks to be applied later can be applied around the magnetic core with an at least approximately constant spacing around the main body 10. In addition, by the part 22 of the encasing 20, the conductor tracks at the edge with respect to the inner region 30 are protected from damage being caused by sharp edges.

FIG. 6 shows a cross section through a magnetic core according to a further embodiment. This embodiment is to the greatest extent identical to the previously described embodiments and differs in particular in that an additional protective element 25 has been introduced into the inner region 30 of the main body 10. The protective element 25 may be a prefabricated component which is introduced into the inner region 30 of the main body 10. For example, the protective element 25 may be an injection-molded part or the like. The protective element 25 may be adhesively bonded or welded to the main body 10 or connected to the main body 10 in some other way. Furthermore, the protective element 25 may also be pressed into the inner region 30 of the main body 10. The form of the protective element 25 is adapted to the form of the inner region 30 of the main body. If for example the inner region 30 has a round cross section, the protective element 25 may for example be formed as a hollow cylinder.

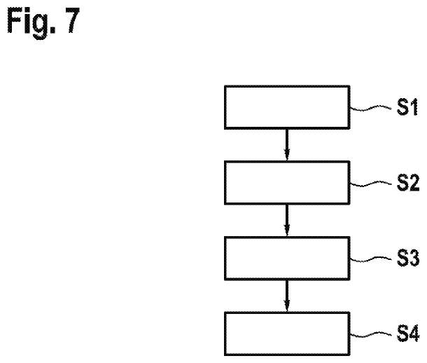

FIG. 7 shows a schematic representation of a flow diagram, as used as a basis for a method for producing a slotted magnetic core according to one embodiment. The method corresponds to the sequence already previously described. In step S1, first a main body 10 comprising a magnetic ferrite is provided, as previously described. The main body may in particular comprise the previously described adjacent subregions 10a and 10b. The main body 10 may either consist completely of magnetic ferrite, or at least comprise magnetic ferrite in a great proportion. As already previously described, the main body 10 may have virtually any desired form. In particular, the main body 10 may have in its outer dimensions a form that corresponds to the outer dimensions of the desired magnetic core to be realized. The main body 10 may have a height of several millimeters to several centimeters. The width of the main body may be several millimeters to several centimeters.

In a further step S2, multiple gaps 11 are introduced into the main body 10. The gaps preferably run radially in relation to a virtual axis A-A in the main body 10. In particular, the gaps 11 only penetrate partially into the main body 10 in the axial or radial direction. In this way, a main body 10 in which the first subregion 10a has gaps 11, while the second subregion 10b has no gaps, is obtained. The individual parts in the first subregion 10a are consequently held together by the unitary second subregion 10b. As already previously described, the introduction of the gaps 11 into the main body 10 may be performed by means of any desired method. In principle, it is also possible already in the production of the main body 10 to provide a main body that already has a first subregion 10a with gaps 11 and a second subregion 10b without gaps 11. In this case, steps S1 and S2 coincide.

In step S3, the main body 10 with the gaps 11 is encased in an electrically insulating material. That is to say that the main body 10 with the gaps 11 is at least partially coated with the electrically insulating material on its outer side. The encasing of the main body 10 may be performed by means of any desired suitable method. In particular, the encasing of the main body 10 may be performed by means of injection-molding processes. A structuring of the encasing may possibly also be performed at the same time. In this way, further functional properties of the encasing can be realized. For example, a path of the conductor track routing on the outer side of the magnetic core may be provided by a structuring of the encasing. Furthermore, the encasing may also at the same time provide a connecting element for wires or leads.

Finally, in step S4, a removal of an inner region 30 of the main body 10 is performed. The second subregion 10b of the main body 10 is thereby removed. In this way, the main body 10 “breaks up” into multiple individual segments 12 comprising magnetic ferrite. These individual segments 12 are only held together by the encasing 20 around the main body 10.

To sum up, the present invention relates to a slotted magnetic core with multiple gaps, and also to a production method for such a magnetic core. For this purpose, in a main body of a magnetic ferrite multiple gaps are introduced into the main body, but only penetrate partially into the main body. Subsequently, the main body with the gaps is fixed by an encasing and then a region of the main body is removed, so that the magnetic ferrite breaks up into multiple individual segments, which are only held together by the encasing.

1. A method for producing a magnetic core, the method comprising the following steps:
providing (S1) a main body (10) comprising a magnetic ferrite, the main body (10) having along a virtual axis (A-A) in an axial direction and/or radial direction a first subregion (10a) and a second subregion (10b);
introducing (S2) multiple gaps (11) into the first subregion (10a) of the main body (10), the gaps (11) running radially in relation to the virtual axis (A-A) in the main body (10);
encasing (S3) the main body (10) with the gaps (11) in an electrically insulating material, for mechanically stabilizing the main body (10) with the gaps (11); and
removing (S4) the second subregion (10b) of the main body (10).

2. The method as claimed in claim 1, the gaps (11) in the main body (10) having a maximum width of less than one millimeter.

3. The method as claimed in claim 1, the removal (S4) of the second subregion (10b) comprising drilling, milling, grinding and/or cutting.

4. The method as claimed in claim 1, the main body (10) having a rotationally symmetrical form, and the virtual axis (A-A) of the main body (10) corresponding to an axis of symmetry of the rotationally symmetrical main body.

5. The method as claimed in claim 1, the main body (10) having a rectangular, square, circular or oval cross section.

6. The method as claimed in claim 1, the encasing (S4) of the main body (10) being performed by an injection-molding process.

7. The method as claimed in claim 1, the encasing (S4) of the main body (10) comprising an introduction of the electrically insulating material into the gaps (11).

8. A magnetic core, with a main body (10) comprising a magnetic ferrite, which has a material-free inner region (30) along a virtual axis (A-A), with multiple radially running gaps (11) in the main body (10), and the main body (10) being at least partially encased in an electrically insulating material, which stabilizes the main body (10) with the gaps (11).

9. The magnetic core as claimed in claim 8, the gaps (11) dividing the main body (10) into multiple individual segments (12) and the gaps (11) in the main body (10) having a width of less than 1 mm.

10. The magnetic core as claimed in claim 8, the electrically insulating material encasing the main body (10) protruding at least partially into the inner region (30) of the main body (10).

11. The magnetic core as claimed in claim 8, with a protective element (25), which is arranged on a side of the main body (10) that is facing the inner region (30).

12. The magnetic core as claimed in claim 8, the gaps (11) having a variable width (b) in a radial direction and/or in a direction parallel to the axis of symmetry (A-A).
